(19) United States
(12) Patent Application Publication
(10) Pub. No.: US 2010/0325683 A1
(43) Pub. Date: Dec. 23, 2010

(54) Media broadcast emulator

(75) Inventors: Jeyhan Karaoguz, Irvine, CA (US); James D. Bennett, Hroznetin (CZ)

Correspondence Address: GARLICK HARRISON & MARKISON, P.O. BOX 160727, AUSTIN, TX, 78716-0727, US

(73) Assignee: BROADCOM CORPORATION, IRVINE, CA (US)

(21) Appl. No.: 12/696,646

(22) Filed: Jan. 29, 2010

Related U.S. Application Data
(60) Provisional application No. 61/218,039, filed on Jun. 17, 2009.
(60) Provisional application No. 61/218,045, filed on Jun. 17, 2009.

(51) Int. Cl. H04N 7/173; G06F 17/00

(52) U.S. Cl. 725/134; 700/94

(57) ABSTRACT

Media broadcast emulator. A media processing device is operative to create a live program type experience for a user. Various types of media are combined to emulate a live media broadcast. Different portions of various media types (e.g., real-time media, stored media, etc.) may be combined to generate a program that emulates a live program. First media can be analyzed to identify characteristics thereof (e.g., meta data associated therewith: (1) music media: song title, rating, artist name, album name, year, track number, genre, author, publisher, etc., (2) disk jockey/talk radio commentary media: speaker, date of first broadcast, station affiliate, broadcast locale, etc.). Based on these identified characteristics, second media related to the first media may be combined with the first media to generate an emulation of a live media broadcast. Alternatively, it is noted that any desired playlist may also be constructed by combining user-selected and/or related media as well.

### CROSS REFERENCE TO RELATED PATENTS/PATENT APPLICATIONS

### Provisional Priority Claims

The present U.S. Utility patent application claims priority pursuant to 35 U.S.C. §119(e) to the following U.S. Provisional patent applications which are hereby incorporated herein by reference in their entirety and made part of the present U.S. Utility patent application for all purposes:

1. U.S. Provisional Application Ser. No. 61/218,039, entitled “Replacing first sourced media with second sourced media based on first sourced media quality,” (Attorney Docket No. BP20030), filed Jun. 17, 2009, pending.

2. U.S. Provisional Application Ser. No. 61/218,045, entitled “Media broadcast emulator,” (Attorney Docket No. BP20030.1), filed Jun. 17, 2009, pending.

### Incorporation by Reference

The following U.S. Utility patent application is hereby incorporated herein by reference in its entirety and is made part of the present U.S. Utility patent application for all purposes:

1. U.S. Utility application Ser. No. 12/______, entitled “Replacing first sourced media with second sourced media based on first sourced media quality,” (Attorney Docket No. BP20030), filed concurrently on, pending.

### BACKGROUND OF THE INVENTION

1. Technical Field of the Invention

The invention relates generally to devices operable to output media; and, more particularly, it relates to management and processing of media to generate a playlist or program such as that may emulate a live media broadcast.

2. Description of Related Art

The amount of media available for user consumption and enjoyment continues to grow a staggering rate. There seems to be an insatiable market for providing news, media, and information to users. Users continually seek such information via a variety of avenues.

There are a variety of devices available for a user to enjoy media today. However, even with this availability of such devices, there still does not exist an adequate means in the art by which media may be managed and controlled by a user for enjoyment in accordance with a number of possible user preferences. While there continues to be development in the art to try to meet these desires, there are significant limitations to the flexibility by which a user may select and tailor output media in accordance with a user's preference.

### BRIEF SUMMARY OF THE INVENTION

The present invention is directed to apparatus and methods of operation that are further described in the following Brief Description of the Several Views of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1A illustrates an embodiment of a computer.

FIG. 1B illustrates an embodiment of a laptop computer.

FIG. 1C illustrates an embodiment of a high definition (HD) television.

FIG. 1D illustrates an embodiment of a standard definition (SD) television.

FIG. 1E illustrates an embodiment of a handheld media unit.

FIG. 1F illustrates an embodiment of a set top box (STB).

FIG. 1G illustrates an embodiment of a digital video disc (DVD) player.

FIG. 1H illustrates an embodiment of a generic media processing device.

FIG. 2 illustrates an embodiment of an apparatus that is operative to combine first media and second media thereby generating third media based on characteristics thereof or user-selected criteria.

FIG. 3 illustrates an embodiment of an apparatus that is operative to combine broadcast media and stored media thereby generating output media.

FIG. 4 illustrates an embodiment of an apparatus that is operative to combine media that is selected from one or more of a number of media sources.

FIG. 5 illustrates an embodiment of combination of broadcast media and stored media thereby generating output media.

FIG. 6 illustrates an alternative embodiment of combination of broadcast media and stored media thereby generating output media.

FIG. 7 illustrates yet another alternative embodiment of combination of broadcast media and stored media thereby generating output media.

FIG. 8 illustrates an embodiment of output media generated based upon a playlist retrieved via a network segment.

FIG. 9 illustrates an embodiment of various characteristics that may be associated with various types of media.

FIGS. 10A, 10B, 11A, 11B, 12A, 12B, 13A, 13B, 14A, and 14B illustrate alternative embodiments of methods for outputting media, selected from at least two media sources, based on quality thereof.

### DETAILED DESCRIPTION OF THE INVENTION

A novel means is presented herein by which a media may be generated to emulate a media broadcast. The media referred to herein may be a plurality of media that undergo combination to generate output media. The media being combined may be individual media (e.g., individual songs, individual video clips, individual photos, etc.), or the media may alternatively be sequences or streams of media (e.g., a sequence or stream of songs, individual video clips, individual photos, etc.). After two or more media undergo combination, the generated or combined media may be viewed as a sequence or stream or media composed of media from one or more media sources. In other words, the generated or combined media may itself be viewed as being a sequence or stream of media generated by as few as two individual media or as being a sequence or stream of media generated by one or more media sequences or streams (or by selected individual media within one or more media sequences or streams).

For example, in one embodiment, a first media (e.g., a first individual media or media clip) and a second media (e.g., a second individual media or media clip) are combined to generated a third media (e.g., a sequence generated by the first individual media or media clip followed by the second individual media or media clip, or vice versa). In another embodiment, a first media (e.g., a first media sequence composed of individual media or media clips) and a second media (e.g., a second media sequence composed of individual media or media clips) are combined to generated a third media (e.g., a third media sequence composed of the individual media or media clips from each of the first media sequence and the second media sequence that undergo combination in a given manner).

The selection parameters by which the various media is combined to generate a media that is emulative of a media broadcast may be user defined. Various types of media may be combined to generate such an emulated media broadcast, and even some ‘live’ or very recently received broadcast media may be included within the emulated media broadcast. Certain types of media that may included within the emulated media broadcast includes music media, news media, weather forecast media, disk jockey (DJ) commentary, talk radio commentary, etc.

Generally speaking, a live broadcast experience, via an emulated media broadcast, is generated for consumption and enjoyment by a user. Selective combination of first media from a first media source and second media from a second media source (e.g., by interleaving, placing adjacent to one another, etc.) generates the emulated media broadcast.

There are a variety of types of devices that are operative to perform the management of supplemental content associated with such media to effectuate an improved user experience. Some examples of such devices are described below.

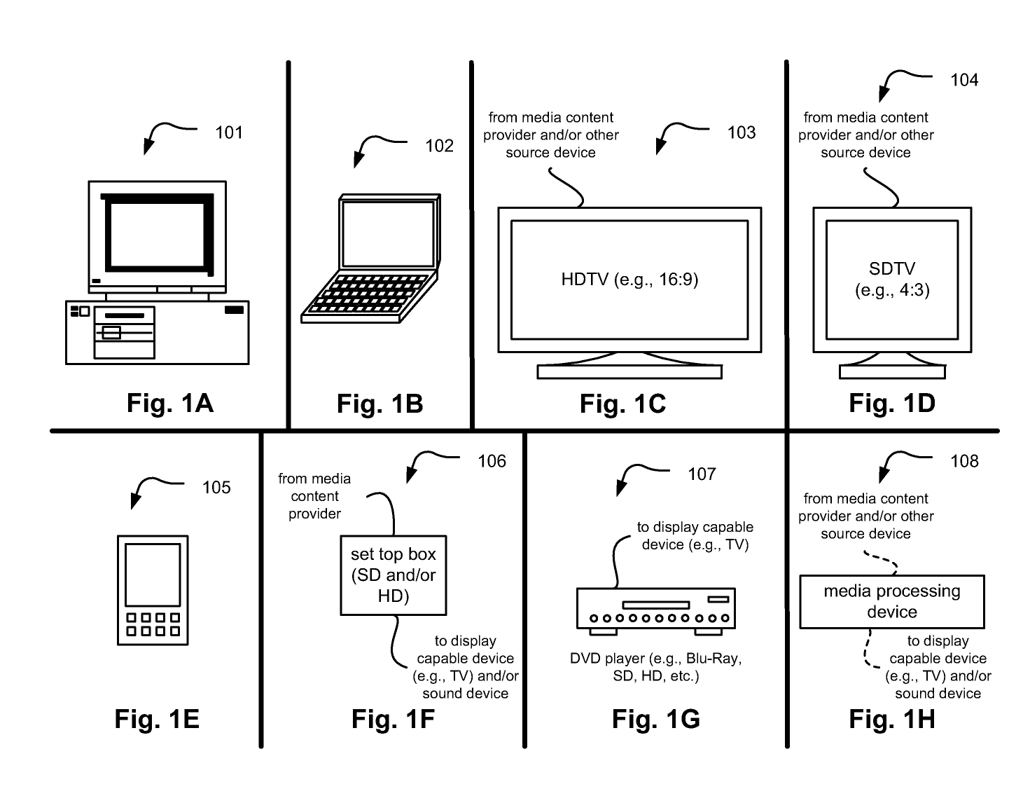

FIG. 1A illustrates an embodiment of a computer 101. The computer 101 can be a desktop computer, or an enterprise storage devices such a server, of a host computer that is attached to a storage array such as a redundant array of independent disks (RAID) array, storage router, edge router, storage switch and/or storage director. A user is able to view still digital images or video (e.g., a sequence of digital images) using the computer 101. Oftentimes, various image viewing capabilities and/or media player capabilities are included on a computer 101 to allow a user to view such images (including video). Also, certain embodiments of such a computer 101 can include one or more audio output devices (e.g., speakers either coupled to the computer 101 or integrated within the computer 101) to allow the outputting of audio content as well.

FIG. 1B illustrates an embodiment of a laptop computer 102. Such a laptop computer 102 may be found and used in any of a wide variety of contexts. In recent years, with the ever-increasing processing capability and functionality found within laptop computers, they are being employed in many instances where previously higher-end and more capable desktop computers would be used. As with the computer 101, the laptop computer 102 may include various image viewing capabilities and/or media player capabilities to allow a user to view such images (including video). The laptop computer 102 may also include or be coupled to one or more audio output devices (e.g., speakers).

FIG. 1C illustrates an embodiment of a high definition (HD) television 103. Many HD televisions 103 include an integrated tuner to allow the receipt, processing, and decoding of media content (e.g., television broadcast signals) thereon. Alternatively, sometimes an HD television 103 receives media content from another source such as a digital video disc (DVD) player, set top box (STB) that receives, processes, and decodes a cable and/or satellite television broadcast signal (or alternatively, an over the air broadcast signal). Regardless of the particular implementation, the HD television 103 may be implemented to perform media processing as described herein. Generally speaking, an HD television 103 has capability to display HD media content and oftentimes is implemented having a 16:9 widescreen aspect ratio. Clearly, other aspect ratios other than merely 16:9 may be implemented within such an HD television 103. Such an HD television 103 typically will include integrated speakers. Also, such a HD television 103 may be implemented cooperatively with an external sound system that outputs audio content.

FIG. 1D illustrates an embodiment of a standard definition (SD) television 104. Of course, an SD television 104 is somewhat analogous to an HD television 103, with at least one difference being that the SD television 104 does not include capability to display HD media content, and an SD television 104 oftentimes is implemented having a 4:3 full screen aspect ratio. Nonetheless, even an SD television 104 may be implemented to perform media processing as described herein. As mentioned above with respect to another television type, such an SD television 104 typically will include integrated speakers. Also, such a SD television 104 may be implemented cooperatively with an external sound system that outputs audio content.

FIG. 1E illustrates an embodiment of a handheld media unit 105. A handheld media unit 105 may operate to provide general storage or storage of image/video content information such as joint photographic experts group (JPEG) files, tagged image file format (TIFF), bitmap, motion picture experts group (MPEG) files, Windows Media Architecture (WMA) files, other types of video content such as MPEG4 files, etc. for playback to a user, and/or any other type of information that may be stored in a digital format. Historically, such handheld media units were primarily employed for storage and playback of audio media; however, such a handheld media unit 105 may be employed for storage and playback of virtual any media (e.g., audio media, video media, photographic media, etc.). Moreover, such a handheld media unit 105 may also include other functionality such as integrated communication circuitry for wired and wireless communications. Such a handheld media unit 105 may be implemented to perform media processing as described herein.

FIG. 1F illustrates an embodiment of a set top box (STB) 106. As mentioned above, sometimes a STB 106 may be implemented to receive, process, and decode a cable and/or satellite television broadcast signal to be provided to any appropriate display capable device such as SD television 104 and/or HD television 103. Such an STB 106 may operate independently or cooperatively with such a display capable device to perform media processing as described herein.

FIG. 1G illustrates an embodiment of a digital video disc (DVD) player 107. Such a DVD player may be any one of a Blu-Ray DVD player, an HD capable DVD player, an SD capable DVD player, and an up-sampling capable DVD player (e.g., from SD to HD, etc.) without departing from the scope and spirit of the invention. The DVD player may provide a signal to any appropriate display capable device such as SD television 104 and/or HD television 103. The DVD player 105 may be implemented to perform media processing as described herein.

FIG. 1H illustrates an embodiment of a generic media processing device 108. Again, as mentioned above, these various devices described above do not include an exhaustive list of devices in which the media processing described herein may be effectuated, and it is noted that any generic digital media processing device 108 may be implemented to perform the media processing described herein without departing from the scope and spirit of the invention.

It is noted that any of a wide variety of media capable devices may incorporate various aspects of the invention presented herein. While many such devices are described above with respect to FIGS. 1A-1H, these diagrams do not constitute an exhaustive list of such media capable devices, and any media capable device (e.g., including portable devices, multi-functional devices [such as a combined phone/media capable device], a media capable device implemented within a vehicle, etc.) may be implemented in accordance with the various aspects of the invention presented herein.

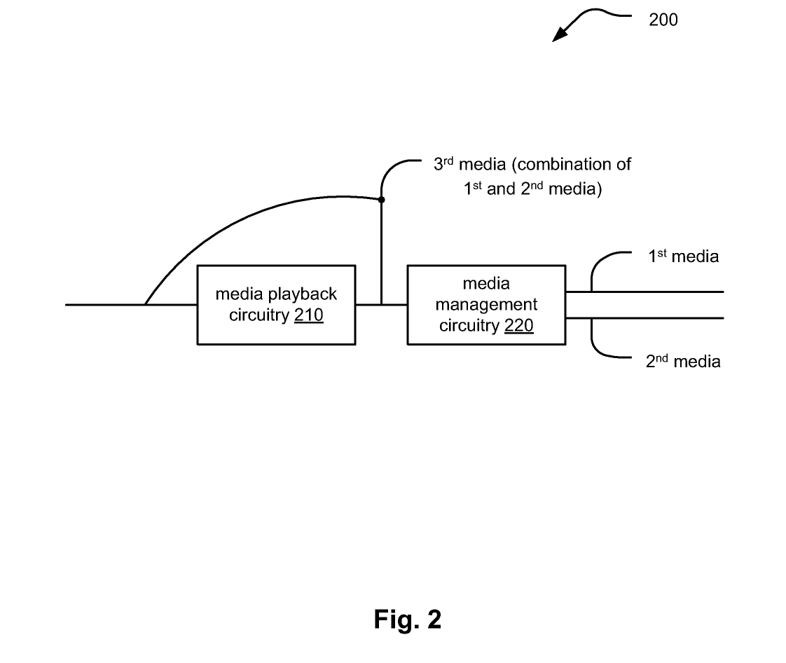

FIG. 2 illustrates an embodiment of an apparatus 200 that is operative to combine first media and second media thereby generating third media based on characteristics thereof or user-selected criteria. The apparatus 200 includes a media playback circuitry 210 that is operative to output any one of various types of media (e.g., audio media, video media, pictorial media, etc.). The apparatus 200 also includes a media management circuitry 220 that is operative to analyze first media provided from a first media source to identify first characteristics associated with the first media. Based on the first characteristics associated with the first media and based on second characteristics associated with second media provided from a second media source, the media management circuitry 220 is operative to combine the first media with the second media thereby generating third media. Then, the media playback circuitry 210 is operative to output the third media.

In one embodiment, the third media is a combination of the first media and the second media that is generated based on the associated characteristics of the first media and the second media. The characteristics associated with media may be of any of a variety of types including the meta data that is often associated with media (e.g., in the digital context). For example, meta data associated with music media may include: song title, rating, artist name, album name, year, track number, genre, author, publisher, etc. Meta data associated with disk jockey/talk radio commentary media may include: speaker, date of first broadcast, station affiliate, broadcast locale, etc. Other types of characteristics associated with media may alternatively include: the language spoken or sung within media, the existence or absence of lyrics within media, the reference of an artist or author within media composed of the spoken commentary, the source provider of such media, the communication medium by which the media has been delivered, etc.

When characteristics of the first media are found to be associated with characteristics of the second media, then the media may be combined to generate output media (e.g., third media). Stated another way, based on the first characteristics associated with the first media and based on second characteristics associated with second media, the media management circuitry 220 is operative to combine the first media with the second media thereby generating third media.

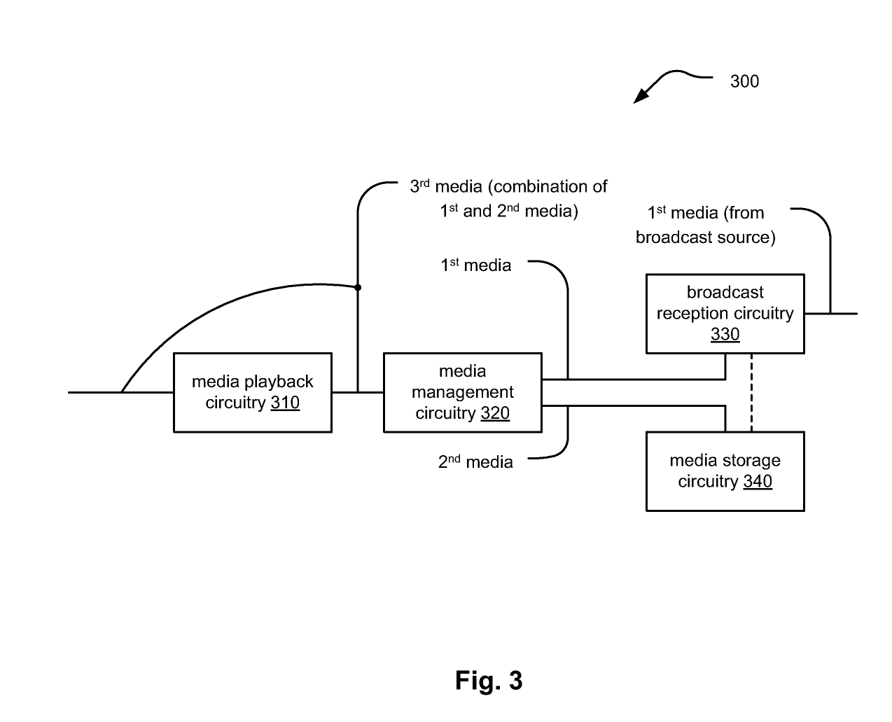

FIG. 3 illustrates an embodiment of an apparatus 300 that is operative to combine broadcast media and stored media thereby generating output media. This diagram shows media management circuitry 320 that is operative to receive first media that is provided from a broadcast source (e.g., via a broadcast reception circuitry 330) and second media that is retrieved from a media storage circuitry 340. The broadcast source may be any one of a variety of broadcast sources such as radio [such as AM or FM], satellite [such as XM radio, Sirius, or some other service provider], streaming over the Internet, downloaded from the Internet, via some other wireless communication link [such as a Bluetooth supported communication link, a communication link within a wireless local area network (WLAN/WiFi)], etc.). The second media source is a stored media source which is shown as a media storage circuitry 340 (e.g., a memory device such a hard disk drive (HDD), a read-only memory (RAM), random access memory (ROM), volatile memory, non-volatile memory, static memory, dynamic memory, flash memory, and/or any device that stores digital information). Referring to the diagram, the broadcast media is received via a broadcast reception circuitry 330, and the stored media is retrieved via a media storage circuitry 340.

The apparatus 300 includes a media playback circuitry 310 that is operative to output any one of various types of media (e.g., audio media, video media, pictorial media, etc.) that may be provided from the broadcast reception circuitry 330 and the media storage circuitry 340. The apparatus 300 also includes a media management circuitry 320 that is operative to analyze first media provided from a first media source to identify first characteristics associated with the first media. Based on the first characteristics associated with the first media and based on second characteristics associated with second media provided from a second media source, the media management circuitry 320 is operative to combine the first media with the second media thereby generating third media. Then, the media playback circuitry 310 is operative to output the third media.

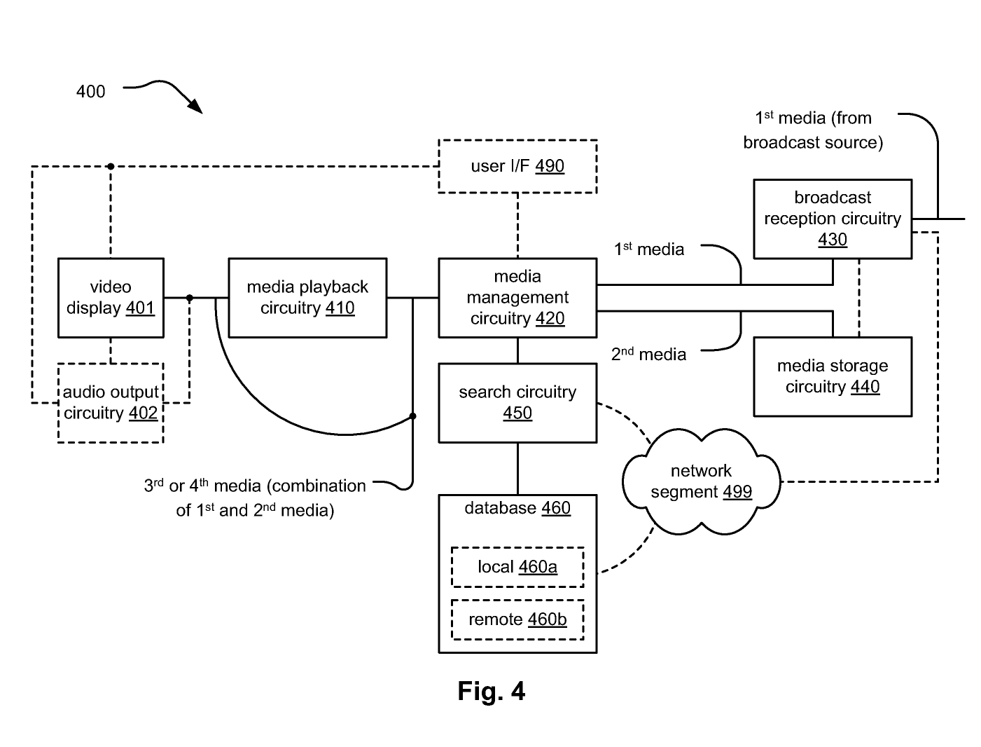

FIG. 4 illustrates an embodiment of an apparatus 400 that is operative to combine media that is selected from one or more of a number of media sources. A broadcast reception circuitry 430 is operative to receive the broadcast media provided from at least one of a plurality of broadcast media sources, and a media playback circuitry 410 is operative to output first media provided from one of the plurality of broadcast media sources. Based on the first characteristics associated with the first media and based on second characteristics associated with second media provided from a second media source, the media management circuitry 420 is operative to combine the first media with the second media thereby generating third media. Then, the media playback circuitry 410 is operative to output the third media.

A search circuitry 450, coupled to the media management circuitry 450, is operative to access at least one database 460 (which may include a local database 460a and/or a remote database 460b) that may include media, ratings of media, a user-interactive forum to allow for updating of ratings, comments, etc. The database 460 may be accessed via a network segment 499 (e.g., an intranet connection, an Internet connection, a wireless local area network (WLAN/WiFi), etc.). In addition, the broadcast reception circuitry 430 may receive streaming media (or media that is downloaded) via the network segment 499.

A user interface 490 is operative to receive user input. This user interface 490 may include a means by which user input may be received so that a user may toggle between live media (e.g., received from the broadcast reception circuitry 430) and an emulated media broadcast. Also, the user interface 490 may include a means by which user input may be received to rank or rate the currently playing media (e.g., ranking of a song currently being played, ranking of DJ commentary currently being played, etc.); another type of input may also include a means by which the currently playing media may be added to a favorites list or other preferred playlist.

In some embodiments, the user interface 490 is operative to receive user input corresponding to a first user rating of the first media while the first media is being output by the media playback circuitry 410 or a second user rating of the second media while the second media is being output by the media playback circuitry 410. The media management circuitry 420 may include a memory circuitry that is operative to store at least one of the first user rating and the second user rating.

The media playback circuitry 410 may itself include an integrated display to display video or pictorial media and integrated speakers to output audio media (or the audio component of video or pictorial media). Alternatively, media that is output from the media playback circuitry 410 may be coupled to an external video display 401 to display video or pictorial media and/or an audio output circuitry 402 to output audio media (or the audio component of video or pictorial media).

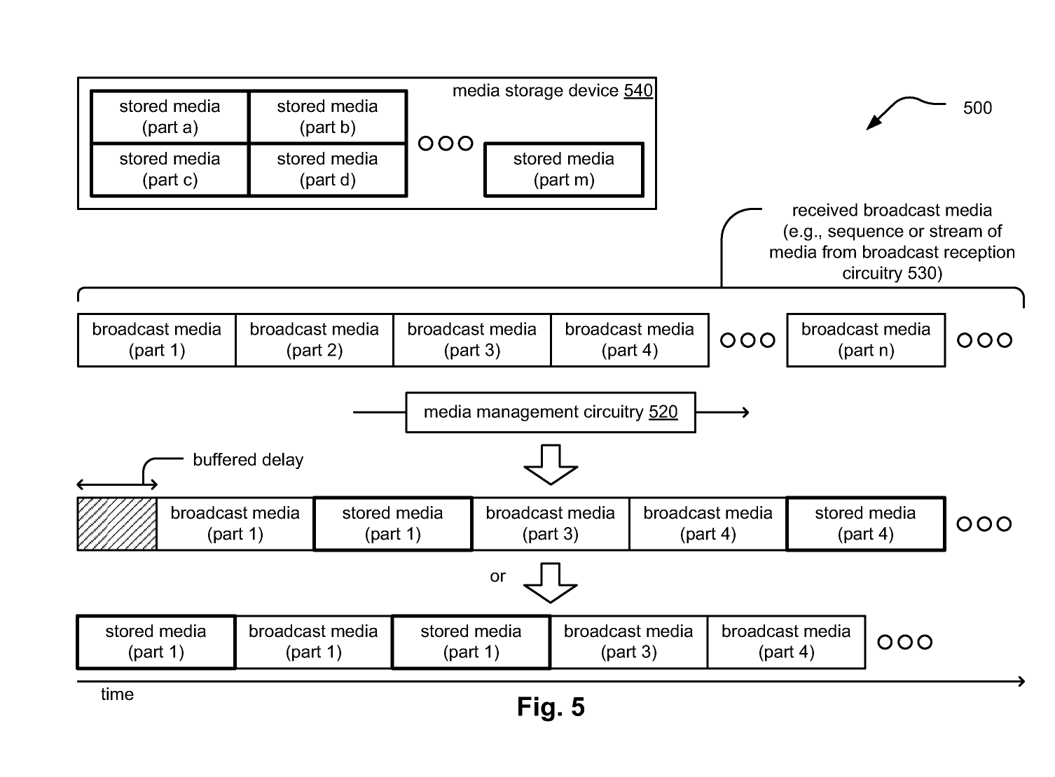

FIG. 5 illustrates an embodiment 500 of combination of broadcast media and stored media thereby generating output media. Portions of broadcast media may be received via a broadcast reception circuitry 530 (e.g., shown as part 1 through part n in this diagram) are combined with stored media (e.g., shown as including part a, part b, part c, part d, and up to part m in this diagram) retrieved from media storage device 540 as shown within media management circuitry 520.

There are various embodiments by which the broadcast media and the stored media may be combined to generate third media are shown in the bottom half of the diagram. A buffered delay may the initial component of the third media. A part 1 of the broadcast media is followed by part 1 of the stored media, which is followed by part 3 of the broadcast media, which is followed by part 4 of the broadcast media, which is followed by part 4 of the stored media, and so on.

In an alternative embodiment, while a buffer is used to collect the broadcast media, playback may be initiated immediately using a portion of the stored media. For example, in this alternative embodiment, a part 1 of the stored media is the initial component of the third media, which is followed by part 1 of the broadcast media, which is followed by part 1 of the stored media, which is followed by part 3 of the broadcast media, which is followed by part 4 of the broadcast media, and so on. There are a wide variety of means by which broadcast media and stored media may be combined to generate output media (third media).

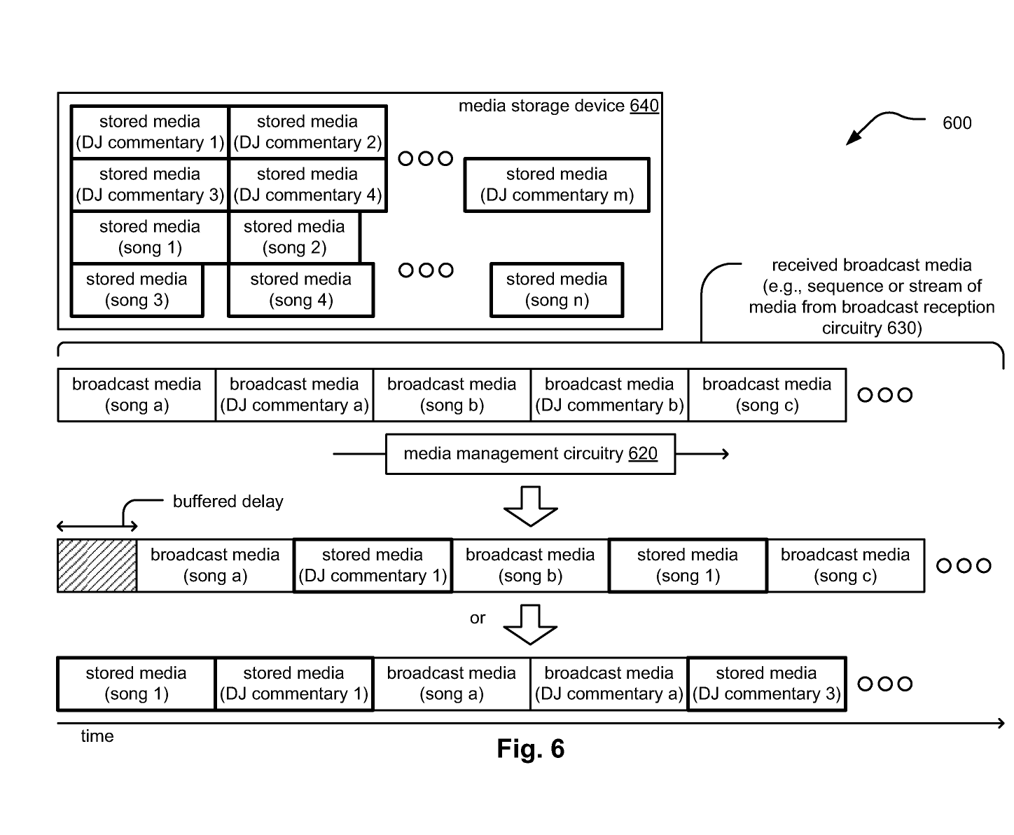

FIG. 6 illustrates an alternative embodiment 600 of combination of broadcast media and stored media thereby generating output media. In this diagram, portions of broadcast media which may be received via a broadcast reception circuitry 630 (e.g., shown as song a, followed by disk jockey (DJ) commentary a, followed by song b, followed by DJ commentary b, followed by song c, etc.) are combined with stored media (e.g., shown as including DJ commentary 1, DJ commentary 2, DJ commentary 3, DJ commentary 4, and up to DJ commentary m, song 1, song 2, song 3, song 4, and up to song n in this diagram) retrieved from media storage device 640 as shown within media management circuitry 620.

There are various embodiments by which the broadcast media and the stored media may be combined to generate third media are shown in the bottom half of the diagram. As also shown within another embodiment described herein, a buffered delay may the initial component of the third media. One possible embodiment of includes song a (from the broadcast media source), which is followed by DJ commentary 1 (from the media storage device 640), which is followed by song b (from the broadcast media source), which is followed by song 1 (from the media storage device 640), which is followed by song c (from the broadcast media source), and so on.

In an alternative embodiment, while a buffer is used to collect the broadcast media, playback may be initiated immediately using a portion of the stored media. For example, in this alternative embodiment, a song 1 (from the media storage device 640), which is followed by DJ commentary 1 (from the media storage device 640), which is followed by song a (from the broadcast media source), which is followed by DJ commentary a (from the broadcast media source), which is followed by DJ commentary 3 (from the media storage device 640), and so on. There are a wide variety of means by which broadcast media and stored media may be combined to generate output media (third media).

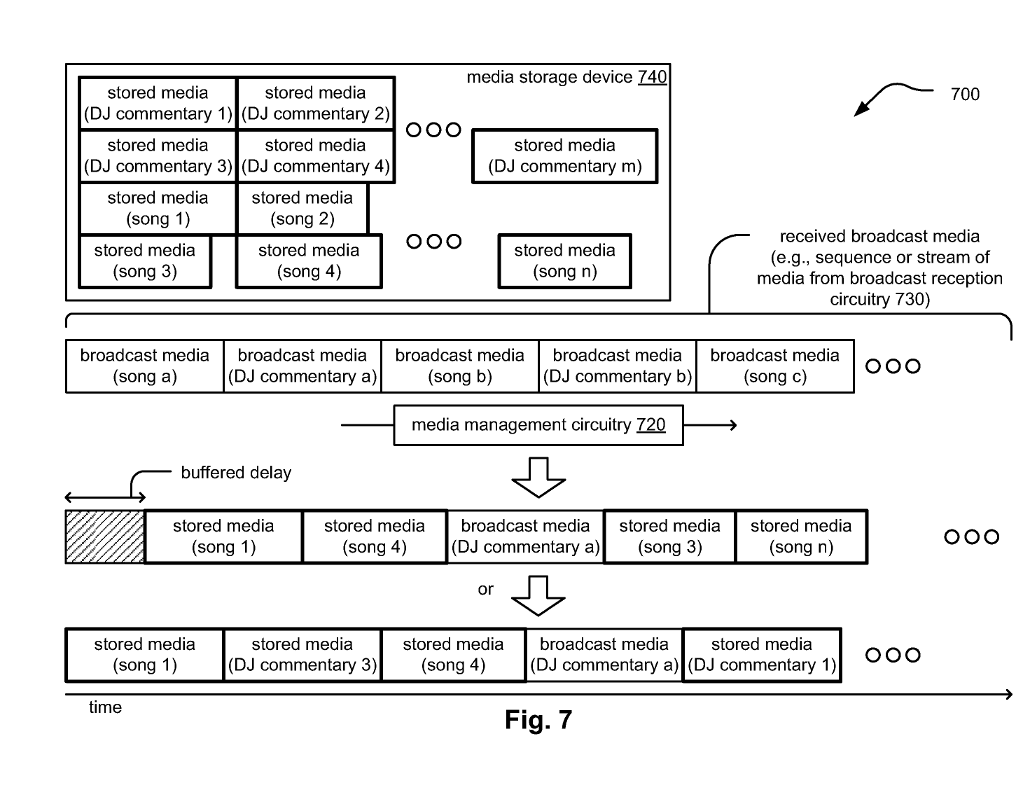

FIG. 7 illustrates yet another alternative embodiment 700 of combination of broadcast media and stored media thereby generating output media. In this diagram, portions of broadcast media may be received via a broadcast reception circuitry 730 (e.g., shown as song a, followed by disk jockey (DJ) commentary a, followed by song b, followed by DJ commentary b, followed by song c, etc.) are combined with stored media (e.g., shown as including DJ commentary 1, DJ commentary 2, DJ commentary 3, DJ commentary 4, and up to DJ commentary m, song 1, song 2, song 3, song 4, and up to song n in this diagram) retrieved from media storage device 740 as shown within media management circuitry 720.

This diagram shows other embodiments by which broadcast media may be combined with stored media to generate output media (third media) that eventually gets output via a media playback circuitry.

Again, as also shown within at least one additional embodiment described herein, a buffered delay may the initial component of the third media. One possible embodiment of includes song 1 (from the media storage device 740), which is followed by song 4 (from the media storage device 740), which is followed by DJ commentary a (from the broadcast media source), which is followed by song 3 (from the media storage device 740), which is followed by song n (from the media storage device 740), and so on.

In an alternative embodiment, while a buffer is used to collect the broadcast media, playback may be initiated immediately using a portion of the stored media. For example, in this alternative embodiment, a song 1 (from the media storage device 740), which is followed by DJ commentary 3 (from the media storage device 740), which is followed by song 4 (from the media storage device 740), which is followed by DJ commentary a (from the broadcast media source), which is followed by DJ commentary 1 (from the media storage device 740), and so on. Again, there are a wide variety of means by which broadcast media and stored media may be combined to generate output media (third media).

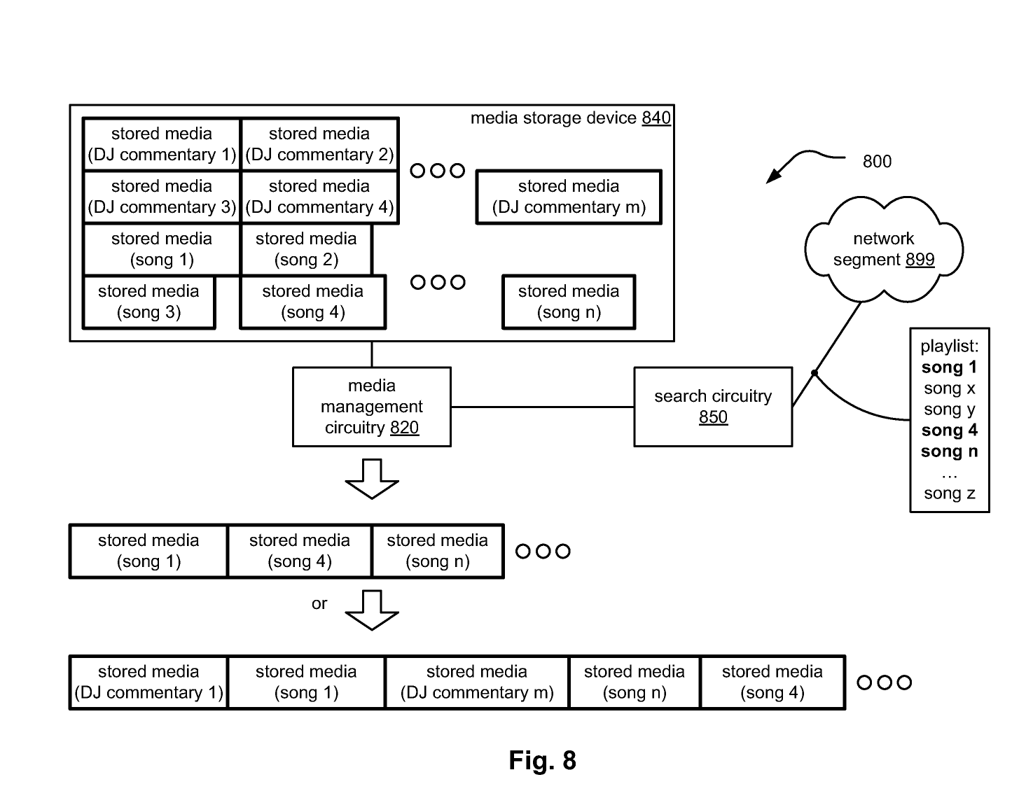

FIG. 8 illustrates an embodiment 800 of output media generated based upon a playlist retrieved via a network segment. This diagram shows how a playlist (e.g., shown as including song 1, song x, song y, song 4, song n, and up to song z). A search circuitry 850 is operative to retrieve the playlist via a network segment 899. The network segment 899 may be the Internet, in one embodiment, and the playlist may be retrieved from a database that is accessed via the Internet. The playlist may be selected based upon user-defined parameters (e.g., preferred genre, preferred artist, preferred time period [for music, such as 70s, 80s, 90s, etc.], preferred language, preferred media content provider, etc.). The media storage device 840 includes including DJ commentary 1, DJ commentary 2, DJ commentary 3, DJ commentary 4, and up to DJ commentary m, song 1, song 2, song 3, song 4, and up to song n in this diagram.

A media management circuitry 820 receives the playlist from the search circuitry 850. Based on a comparison of the playlist with media included within a media storage device 840, the media management circuitry 820 generates a media that includes stored media that is included within the playlist.

For example, if music only media is desirable, output media including song 1, song 4, song n, and so on could be constructed. Alternatively, if a combined music and DJ commentary media is desirable, output media including DJ commentary 1, song 1, DJ commentary m, song n, song 4, and so on could be constructed.

In even other embodiments, media identified within the playlist that is or are not already included within the media storage device 840 may be retrieved and downloaded from the network segment 899 to complete a media that includes all media identified within the playlist.

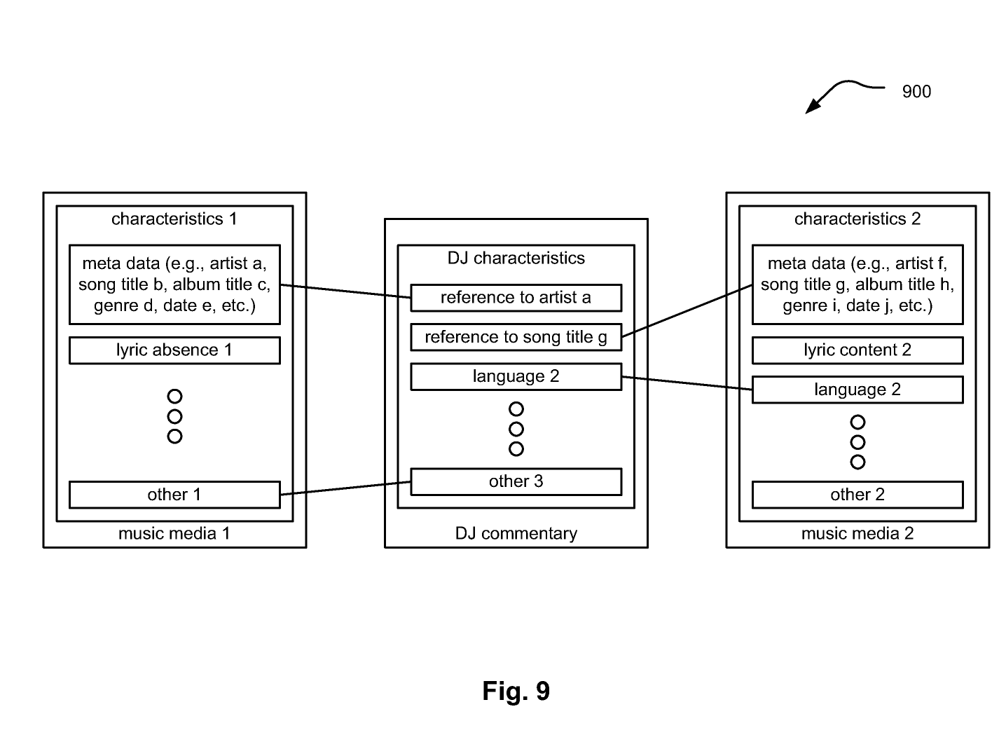

FIG. 9 illustrates an embodiment 900 of various characteristics that may be associated with various types of media. This diagram shows different types of media and how characteristics of each may have at least some commonality. For example, this diagram shows music media 1, music media 2, and DJ commentary. Each of the music media 1 and music media 2 includes characteristics associated therewith. For example, one characteristic associated with music media 1 includes meta data of music media 1 which may include information corresponding to the artist a, song title b, album title c, genre d, date e, etc. Another characteristic associated with music media 1 indicates the absence of lyrics within the music media 1. Any other characteristic may also be associated with music media 1 (e.g., shown as other 1).

For example, considering the music media 2, one characteristic associated with music media 2 includes meta data of music media 2 which may include information corresponding to the artist f, song title g, album title h, genre i, date j, etc. Another characteristic associated with music media 2 indicates the existence of lyrics within the music media 2. Yet another characteristic associated with music media 2 indicates the language of the lyrics sung within the music media 2. Any other characteristic may also be associated with music media 2 (e.g., shown as other 2).

Considering the DJ commentary media, one characteristic associated with the DJ commentary media includes a spoken reference related to artist a (associated with music media 1). Another characteristic associated with the DJ commentary media includes a spoken reference related to song title g (associated with music media 2). Even another characteristic associated with the DJ commentary media includes language 2 (also same language associated with music media 2). Any other characteristic may also be associated with DJ commentary media (e.g., shown as other 3).

Certain of the characteristics associated with various types of media may also be ascertained by analyzing and processing the media. For example, media may be processed to determine if the media is music media based on repeated patterns and melodies therein. Alternatively, media may be processed to determine if the media includes spoken commentary by performing spectral analysis thereof to identify spoken content therein. Clearly, one very straight-forwards means of processing media to ascertain characteristics associated therewith is to analyze the meta data associated with it. There are also many means by which media may be processed to ascertain certain characteristics thereof.

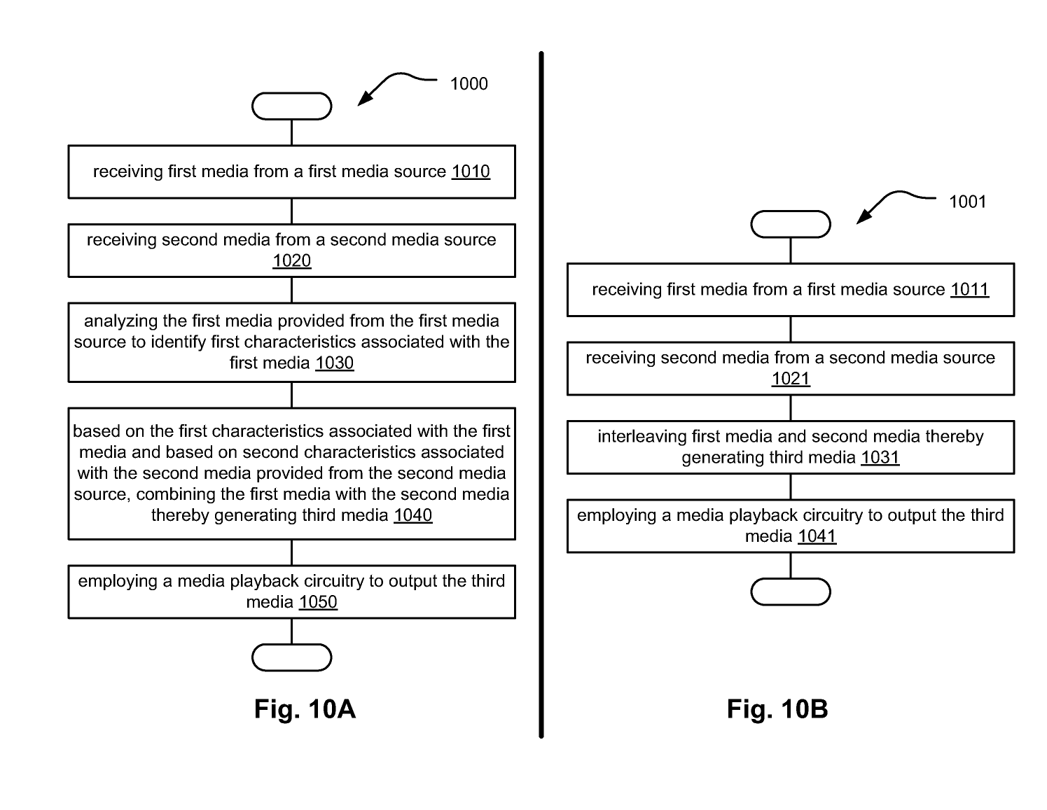

FIGS. 10A, 10B, 11A, 11B, 12A, 12B, 13A, 13B, 14A, and 14B illustrate alternative embodiments of methods for outputting media, selected from at least two media sources, based on quality thereof.

Referring to method 1000 of FIG. 10A, the method 1000 begins by receiving first media from a first media source, as shown in a block 1010. The method 1000 continues by receiving second media from a second media source, as shown in a block 1020. The method 1000 then operates by analyzing the first media provided from the first media source to identify first characteristics associated with the first media, as shown in a block 1030.

The method 1000 continues by based on the first characteristics associated with the first media and based on second characteristics associated with the second media provided from the second media source, combining the first media with the second media thereby generating third media, as shown in a block 1040. The method 1001 then operates by employing a media playback circuitry to output the third media, as shown in a block 1050.

Referring to method 1001 of FIG. 10B, the method 1001 begins by receiving first media from a first media source, as shown in a block 1011. The method 1001 then operates by receiving second media from a second media source, as shown in a block 1021.

The method 1001 continues by interleaving first media and second media thereby generating third media, as shown in a block 1031. The method 1001 then operates by employing a media playback circuitry to output the third media, as shown in a block 1041.

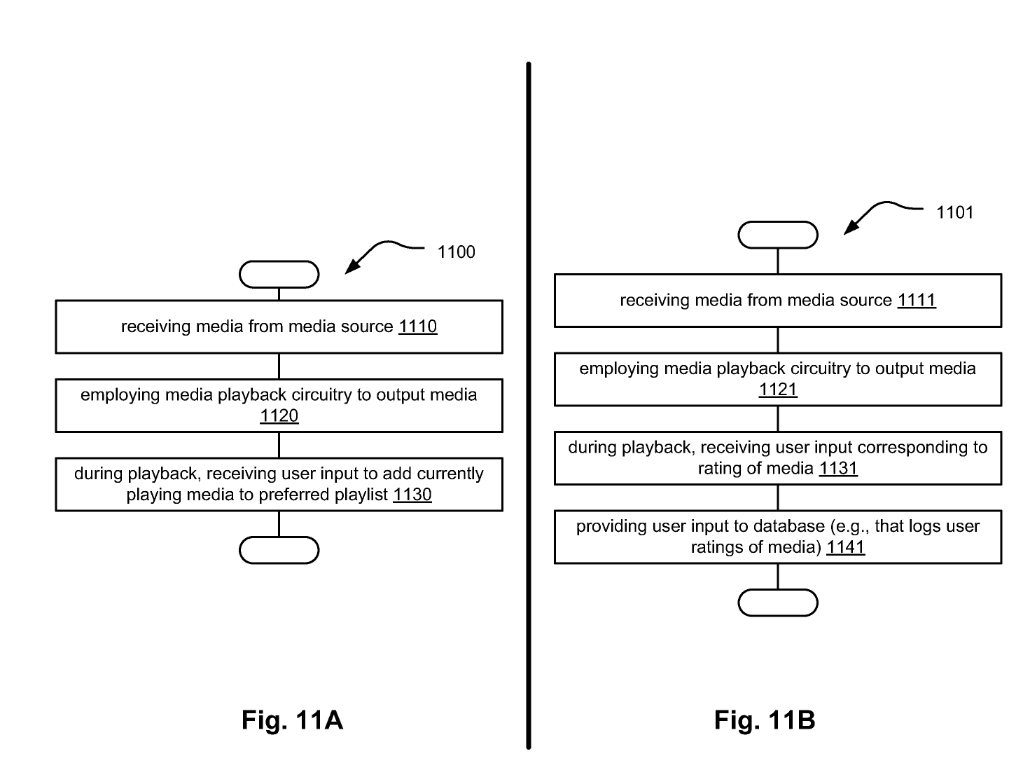

Referring to method 1100 of FIG. 11A, the method 1100 begins by receiving media from media source, as shown in a block 1110. The method 1100 continues by employing media playback circuitry to output media, as shown in a block 1120. The method 1100 then operates by during playback, receiving user input to add currently playing media to preferred playlist, as shown in a block 1130.

Referring to method 1101 of FIG. 11B, the method 1101 begins by receiving media from media source, as shown in a block 1111. The method 1101 then operates by employing media playback circuitry to output media, as shown in a block 1121.

The method 1101 continues by during playback, receiving user input corresponding to rating of media, as shown in a block 1131. The method 1101 then operates by providing user input to database (e.g., that logs user ratings of media), as shown in a block 1141.

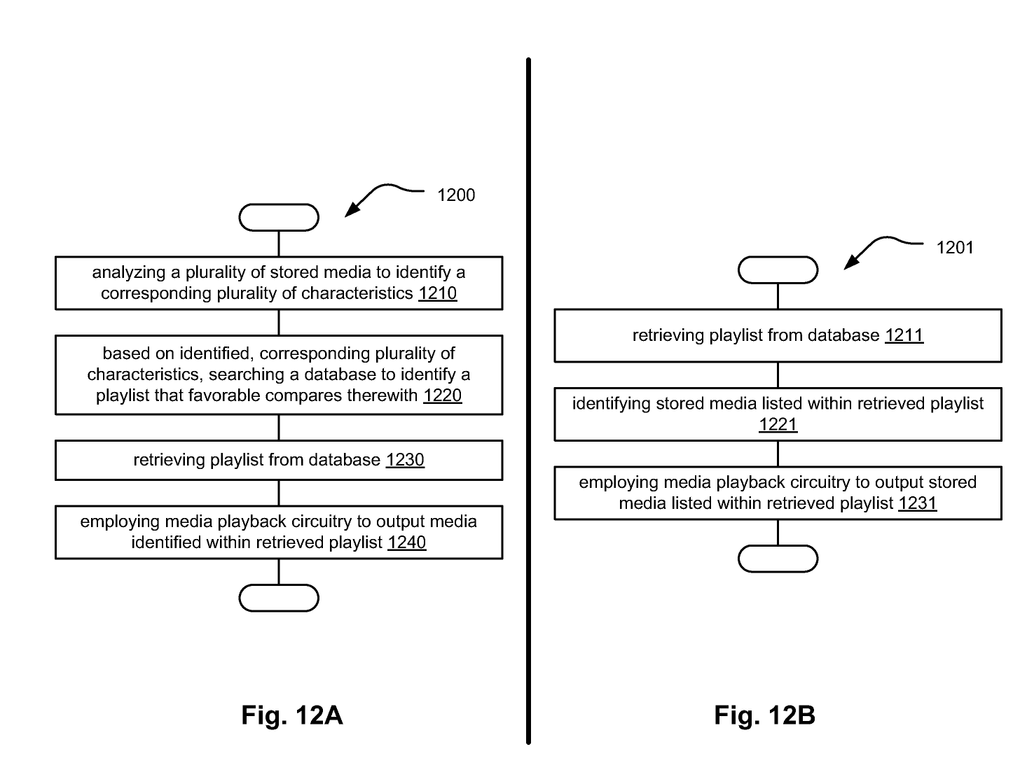

Referring to method 1200 of FIG. 12A, the method 1200 begins by analyzing a plurality of stored media to identify a corresponding plurality of characteristics, as shown in a block 1210. The method 1200 continues by based on identified, corresponding plurality of characteristics, searching a database to identify a playlist that favorable compares therewith, as shown in a block 1220.

The method 1200 then operates by retrieving playlist from database, as shown in a block 1230. The method 1200 continues by employing media playback circuitry to output media identified within retrieved playlist, as shown in a block 1240.

Referring to method 1201 of FIG. 12B, the method 1201 begins by retrieving playlist from database, as shown in a block 1211. The method 1201 then operates by identifying stored media listed within retrieved playlist, as shown in a block 1221. The method 1201 continues by employing media playback circuitry to output stored media listed within retrieved playlist, as shown in a block 1231.

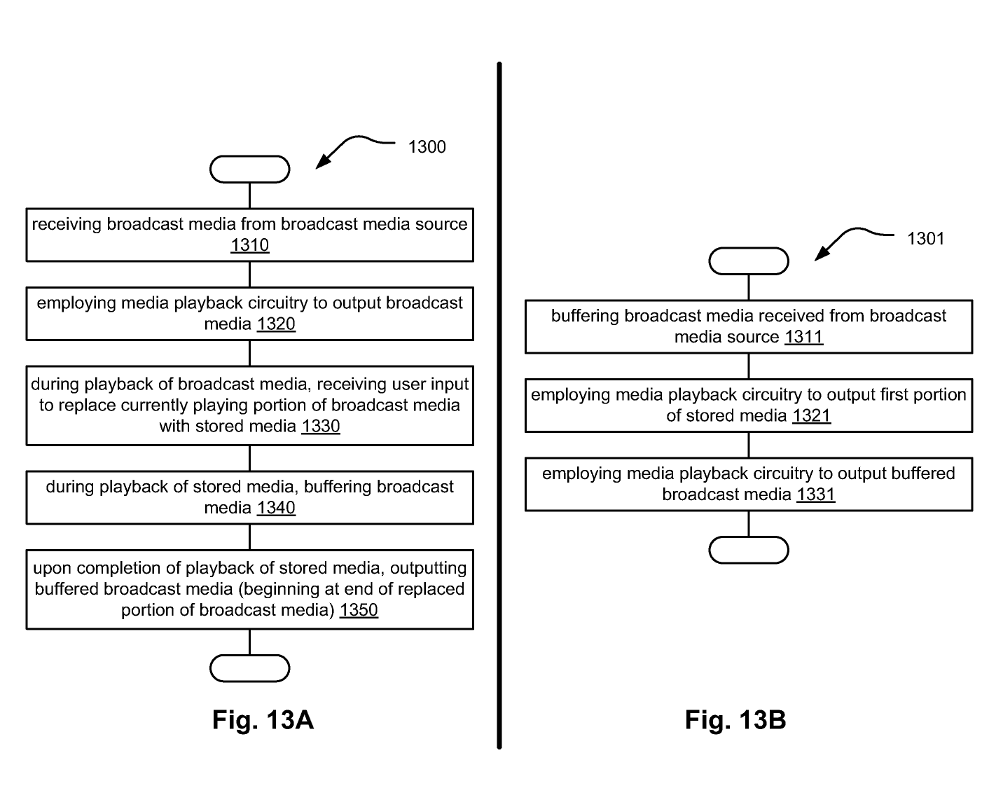

Referring to method 1300 of FIG. 13A, the method 1300 begins by receiving broadcast media from broadcast media source, as shown in a block 1310. The method 1300 continues by employing media playback circuitry to output broadcast media, as shown in a block 1320. The method 1300 then operates by during playback of broadcast media, receiving user input to replace currently playing portion of broadcast media with stored media, as shown in a block 1330.

The method 1300 continues by during playback of stored media, buffering broadcast media, as shown in a block 1340. The method 1400 continues by upon completion of playback of stored media, outputting buffered broadcast media (beginning at end of replaced portion of broadcast media), as shown in a block 1350.

Referring to method 1301 of FIG. 13B, the method 1301 begins by buffering broadcast media received from broadcast media source, as shown in a block 1311. The method 1301 then operates by employing media playback circuitry to output first portion of stored media, as shown in a block 1321. The method 1301 continues by employing media playback circuitry to output buffered broadcast media, as shown in a block 1331.

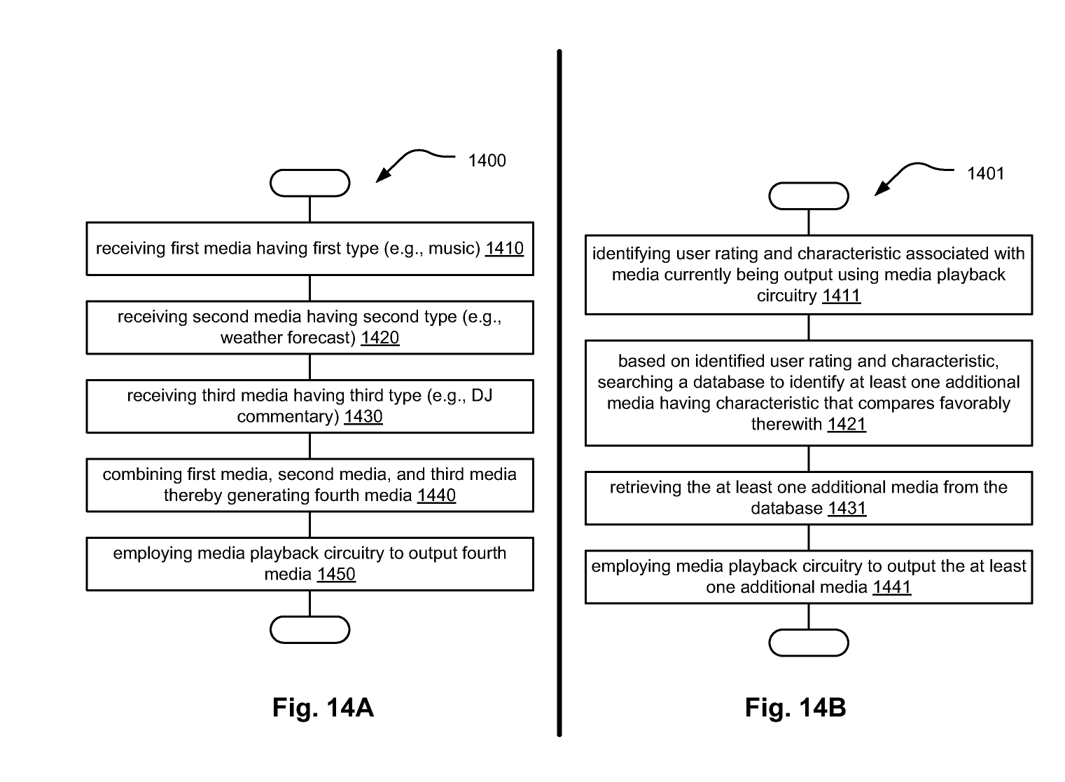

Referring to method 1400 of FIG. 14A, the method 1400 begins by receiving first media having first type (e.g., music), as shown in a block 1410. The method 1400 continues by receiving second media having second type (e.g., weather forecast), as shown in a block 1420. The method 1400 then operates by receiving third media having third type (e.g., DJ commentary), as shown in a block 1430.

The method 1400 continues by combining first media, second media, and third media thereby generating fourth media, as shown in a block 1440. The method 1400 then operates by employing media playback circuitry to output fourth media, as shown in a block 1450.

Referring to method 1401 of FIG. 14B, the method 1401 begins by identifying user rating and characteristic associated with media currently being output using media playback circuitry, as shown in a block 1411. The method 1401 then operates by based on identified user rating and characteristic, searching a database to identify at least one additional media having characteristic that compares favorably therewith, as shown in a block 1421.

The method 1401 continues by retrieving the at least one additional media from the database, as shown in a block 1431. The method 1401 then operates by employing media playback circuitry to output the at least one additional media, as shown in a block 1441.

It is noted that the various circuitries and/or modules (e.g., media management circuitries, media playback circuitries, broadcast reception circuitries, media storage circuitries, etc.) described herein may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The operational instructions may be stored in a memory. The memory may be a single memory device or a plurality of memory devices. Such a memory device may be a read-only memory (ROM), random access memory (RAM), volatile memory, non-volatile memory, static memory, dynamic memory, flash memory, and/or any device that stores digital information. It is also noted that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. In such an embodiment, a memory stores, and a processing module coupled thereto executes, operational instructions corresponding to at least some of the steps and/or functions illustrated and/or described herein.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. An apparatus, comprising:
a broadcast reception circuitry that is operative to receive first media from a broadcast media source;
a media storage circuitry that is operative to store second media;
a media playback circuitry;
a media management circuitry, coupled to the broadcast reception circuitry, the media playback circuitry, and to the media storage circuitry, that is operative to:
analyze the first media provided from the broadcast media source to identify first characteristics associated with the first media;
based on the first characteristics associated with the first media and based on second characteristics associated with second media provided from the media storage circuitry, combine the first media with the second media thereby generating third media; and wherein:
the media playback circuitry is operative to output the third media.

2. The apparatus of claim 1, wherein:
the first media, upon being received from the broadcast media source via the broadcast reception circuitry, is stored within the media storage circuitry; further comprising:
a search circuitry, coupled to the media management circuitry, that is operative to search at least one of a local database and a remote database, based on a plurality of search parameters, to identify a playlist; and wherein:
the search circuitry is operative to retrieve the playlist from the at least one of a local database and a remote database;
the media management circuitry is operative to:
identify portions of the first media and the second media that that are associated within the playlist based on the first characteristics and the first characteristics; and
based on the identified portions of the first media and the second media, modify the playlist thereby generating a modified playlist that includes only the identified portions of the first media and the second media that that are associated within the playlist based on the first characteristics and the first characteristics;
combine the identified portions of the first media and the second media, in accordance with the modified playlist, thereby generating fourth media; and
the media playback circuitry is operative to output the fourth media.

3. The apparatus of claim 1, further comprising:
a user interface, coupled to the media management circuitry and the media playback circuitry, is operative to receive user input to direct the media playback circuitry to output only one of the first media, the second media, and the third media.

4. The apparatus of claim 1, further comprising:
a user interface, coupled to the media management circuitry and the media playback circuitry, is operative to receive user input while the first media is being output via the media playback circuitry or while the second media is being output via the media playback circuitry; and wherein:
the media management circuitry is operative to modify the first characteristics of the first media or to modify the second characteristics of the second media based on the user input.

5. The apparatus of claim 1, wherein:
the first media is music media;
the first characteristics associated with the first media include at least one of an artist name, a song title, an album title, and a music genre;
the second media is audio commentary media; and
the second characteristics associated with second media include at least one of the artist name, the song title, the album title, and the music genre.

6. The apparatus of claim 1, wherein:
the media management circuitry is operative to process the first media to identify at least one of a song title and an artist name associated with at least one portion of the first media; and
the first characteristics associated with the first media include at least one of an identified song title and an identified artist name associated with the at least one portion of the first media.

7. The apparatus of claim 1, wherein:
the media management circuitry is operative to process the first media to identify at least one of a song title and an artist name associated with at least one portion of the first media; and
the first characteristics associated with the first media include at least one of a first identified song title and a first identified artist name associated with a first portion of the first media and at least one of a second identified song title and a second identified artist name associated with a second portion of the first media.

8. An apparatus, comprising:
a media playback circuitry;
a media management circuitry, coupled to the media playback circuitry, that is operative to:
analyze first media provided from a first media source to identify first characteristics associated with the first media;
based on the first characteristics associated with the first media and based on second characteristics associated with second media provided from a second media source, combine the first media with the second media thereby generating third media; and wherein:
the media playback circuitry is operative to output the third media.

9. The apparatus of claim 8, further comprising:
a media storage circuitry, coupled to the media management circuitry, that is operative to store the first media and the second media; and wherein:
the media storage circuitry is the first media source and the second media source.

10. The apparatus of claim 8, further comprising:
a broadcast reception circuitry, coupled to the media management circuitry, that is operative to receive the first media from a broadcast media source; and
a media storage circuitry, coupled to the media management circuitry, that is operative to store the second media; and wherein:
the first media source is the broadcast media source; and
the second media source is the media storage circuitry.

11. The apparatus of claim 8, further comprising:
a media storage circuitry, coupled to the media management circuitry, that is operative to store the first media and the second media;
a search circuitry, coupled to the media management circuitry, that is operative to search at least one of a local database and a remote database, based on a plurality of search parameters, to identify a playlist; and wherein:
the search circuitry is operative to retrieve the playlist from the at least one of a local database and a remote database;
the media management circuitry is operative to:
identify portions of the first media and the second media that that are associated within the playlist based on the first characteristics and the first characteristics; and
based on the identified portions of the first media and the second media, modify the playlist thereby generating a modified playlist that includes only the identified portions of the first media and the second media that that are associated within the playlist based on the first characteristics and the first characteristics;
combine the identified portions of the first media and the second media, in accordance with the modified playlist, thereby generating fourth media; and
the media playback circuitry is operative to output the fourth media.

12. The apparatus of claim 8, further comprising:
a user interface, coupled to the media management circuitry and the media playback circuitry, is operative to receive user input to direct the media playback circuitry to output only one of the first media, the second media, and the third media.

13. The apparatus of claim 8, wherein:
the first media is music media;
the first characteristics associated with the first media include at least one of an artist name, a song title, an album title, and a music genre;
the second media is audio commentary media; and
the second characteristics associated with second media include at least one of the artist name, the song title, the album title, and the music genre.

14. The apparatus of claim 8, wherein:
the media management circuitry is operative to process the first media to identify at least one of a song title and an artist name associated with at least one portion of the first media; and
the first characteristics associated with the first media include at least one of an identified song title and an identified artist name associated with the at least one portion of the first media.

15. The apparatus of claim 8, wherein:
the media management circuitry is operative to process the first media to identify at least one of a song title and an artist name associated with at least one portion of the first media; and
the first characteristics associated with the first media include at least one of a first identified song title and a first identified artist name associated with a first portion of the first media and at least one of a second identified song title and a second identified artist name associated with a second portion of the first media.

16. A method, comprising:
receiving first media from a first media source;
receiving second media from a second media source;
analyzing the first media provided from the first media source to identify first characteristics associated with the first media;
based on the first characteristics associated with the first media and based on second characteristics associated with the second media provided from the second media source, combining the first media with the second media thereby generating third media; and
employing a media playback circuitry to output the third media.

17. The method of claim 16, further comprising:
receiving the first media from a media storage circuitry; and
receiving the second media from the media storage circuitry.

18. The method of claim 16, further comprising:
receiving the first media from a broadcast media source; and
receiving the second media from a media storage circuitry.

19. The method of claim 16, further comprising:
searching at least one of a local database and a remote database, based on a plurality of search parameters, to identify a playlist;
retrieving the playlist from the at least one of a local database and a remote database;
identifying portions of the first media and the second media that that are associated within the playlist based on the first characteristics and the first characteristics;
based on the identified portions of the first media and the second media, modifying the playlist thereby generating a modified playlist that includes only the identified portions of the first media and the second media that that are associated within the playlist based on the first characteristics and the first characteristics;
combining the identified portions of the first media and the second media, in accordance with the modified playlist, thereby generating fourth media; and
employing the media playback circuitry to output the fourth media.

20. The method of claim 16, further comprising:
via a user interface, receiving user input to direct the media playback circuitry to output only one of the first media, the second media, and the third media.

21. The method of claim 16, wherein:
the first media is music media;
the first characteristics associated with the first media include at least one of an artist name, a song title, an album title, and a music genre;
the second media is audio commentary media; and
the second characteristics associated with second media include at least one of the artist name, the song title, the album title, and the music genre.

22. The method of claim 16, further comprising:
processing the first media to identify at least one of a song title and an artist name associated with at least one portion of the first media; and wherein:
the first characteristics associated with the first media include at least one of an identified song title and an identified artist name associated with the at least one portion of the first media.

23. The method of claim 16, further comprising:
processing the first media to identify at least one of a song title and an artist name associated with at least one portion of the first media; and
the first characteristics associated with the first media include at least one of a first identified song title and a first identified artist name associated with a first portion of the first media and at least one of a second identified song title and a second identified artist name associated with a second portion of the first media.
